(19) United States
(12) Patent Application Publication
(10) Pub. No.: US 2005/0231481 A1
(43) Pub. Date: Oct. 20, 2005

(54) System for exerting forces on a user using rolling elements

(76) Inventor: Mike Wittig, Santa Clara, CA (US)

Correspondence Address: MICHAEL WITTIG, 111 SARATOGA AVE. #2326, SANTA CLARA, CA, 95051, US

(21) Appl. No.: 11/107,009

(22) Filed: Apr. 14, 2005

Related U.S. Application Data
(60) Provisional application No. 60/562,347, filed on Apr. 14, 2004.

(51) Int. Cl. G09G 5/00

(52) U.S. Cl. 345/163

(57) ABSTRACT

According to one aspect of the invention, a controllable multi-directional rolling platform for exerting forces on a user is provided comprising a platform contacting a user body part that has a plurality of rolling elements about the periphery of a frame which can rotate along an axis differing from that of the rolling elements, effectively forming a wheel that can roll in two dimensions. The platform is controlled by a computer that uses computing processes to command a signal to a motor, which in turn drives the frame and the rolling elements mounted to it. The platform exerts a force on a user through this action.

### CROSS-REFERENCE TO RELATED APPLICATIONS

This application claims the benefit of U.S. Provisional Application No. 60/562,347, filed on Apr. 14, 2004, the entire disclosure of which is hereby incorporated by reference herein.

### BACKGROUND OF THE INVENTION

1) Field of Invention

This invention relates to a system for exerting forces on a user, more particularly one that uses rolling elements.

2) Discussion of Related Art

An example of a system that exerts forces on a user using rolling elements is a skateboard. A skateboard, however, is limited to travelling in the direction its wheels are generally pointing. It cannot, for example, roll in the direction of its wheels and simultaneously roll in a direction perpendicular to its wheels. An example of a system that tracks position is a computer mouse. As the user moves his or her hand while resting on the mouse, the mouse reports the position of itself to the computer.

### SUMMARY OF THE INVENTION

According to one aspect of the invention, a controllable multi-directional rolling platform for exerting forces on a user is provided comprising a platform contacting a user body part that has a plurality of rolling elements about the periphery of a frame which can rotate along an axis differing from that of the rolling elements, effectively forming a wheel that can roll in two dimensions. The platform is controlled by a computer that uses computing processes to command a signal to a motor, which in turn drives the frame and the rolling elements mounted to it. The platform exerts a force on a user through this action.

### BRIEF DESCRIPTION OF THE DRAWINGS

The invention is further described by way of example with reference to the accompanying drawings wherein:

FIG. 138 is a side view of part of wheel assembly 572 capable of rolling across a surface in 2 dimensions.

FIG. 140 is an isometric view of the components of FIG. 138 showing how driving motors 558 and 556 drive wheel assembly 572.

FIG. 141 is a side view wheel assembly 572 showing how each wheel 542 makes up a section of a complete circle, allowing wheel assembly 572 to rotate continuously.

FIG. 143 is an isometric view of wheel assembly 572 showing two sets of 3 wheels driven by a motor and tracked with a position sensor.

FIG. 144 is an isometric view of a user having a force applied to his or her self by means of 3 wheel assemblies 572 mounted to a platform contacting the user.

FIG. 146 shows an isometric view of a computer mouse that uses wheel assembly 572 to apply forces to a user that grasps it.

FIG. 147 shows an isometric view of a computer mouse using three wheel assemblies 572 but only driving each with a single motor.

FIG. 149 is a block diagram of an embodiment that applies forces to a user under computer control.

### DETAILED DESCRIPTION OF THE INVENTION

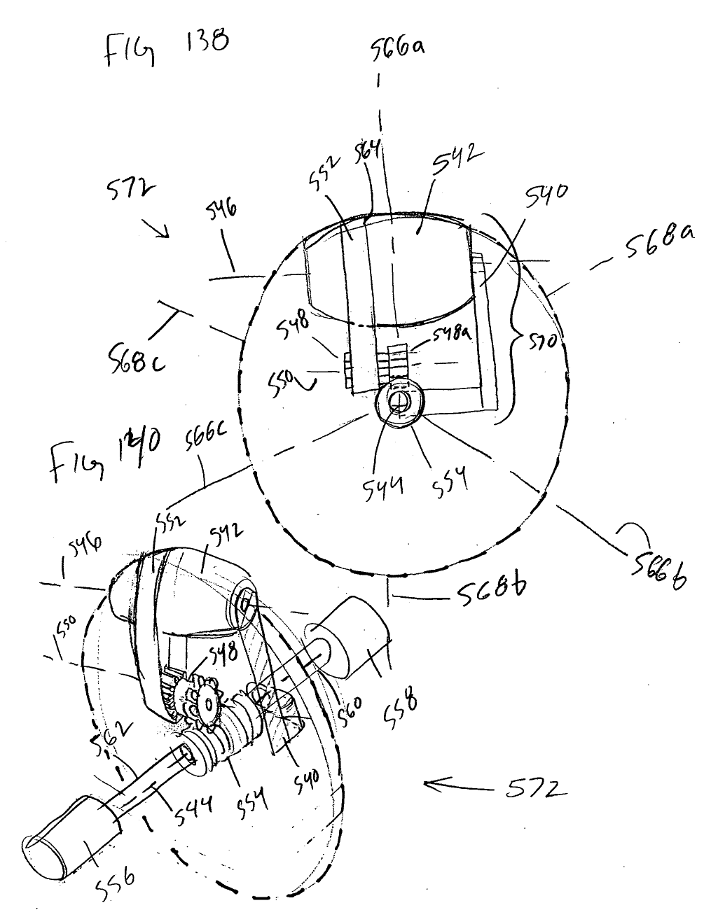

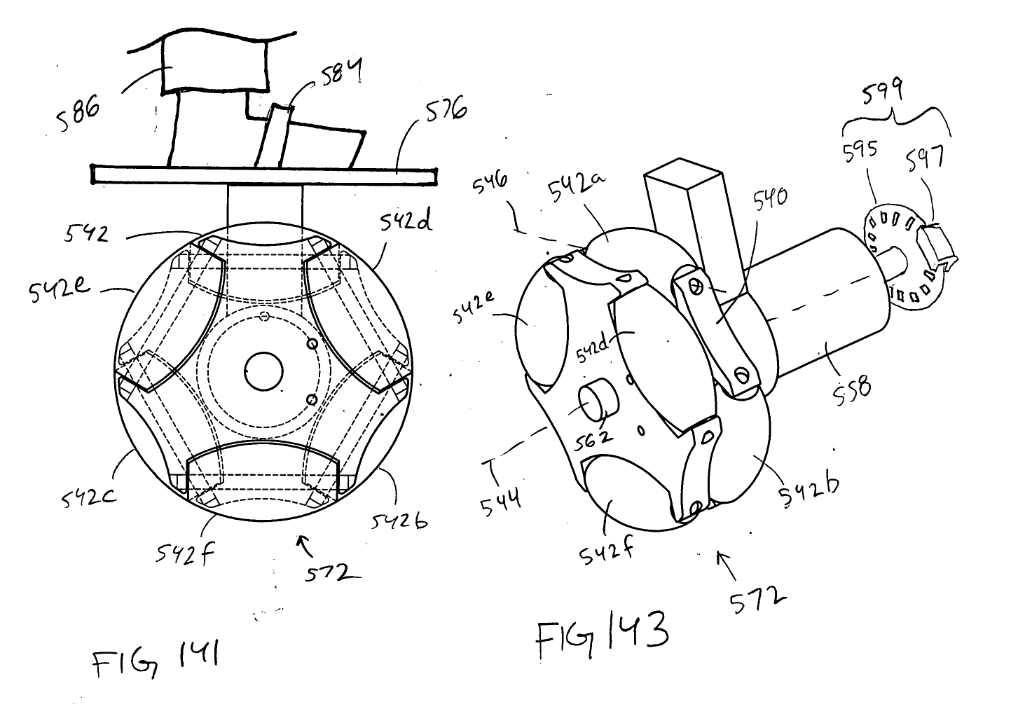

One aspect of the invention is shown in FIGS. 138 and 140. Wheel 542 is rotably attached to frame 540 and rotates about axis 546. Pulley 548 drives belt 552 which rides in groove 564 of wheel 542. Worm gear 554 drives pulley 548 via gear 548a rigidly attached to pulley 548. Worm gear 554 rotates about axis 544. Frame 540 rotates about axis 544. Motor 558 drives tube 560 which in turn rotates frame 540. Motor 556 drives shaft 562 which drives worm gear 554. It should be noted that worm gear 554 and pulley 548 comprise a transmission unit, and that it is clear that this transmission could be built with different ratios and use different components (for example, a planetary transmission could be attached to motor 556 to provide a different ratio or a bevel gear pair could be used in place of the worm gear and pulley to transmit torque at a 90 degree angle).

There are actually 6 of assembly 570 arrayed around axis 544 (the 6 have been omitted for clarity), in two sets of 3 equally spaced assemblies that have axis 546 within the same plane, and the two sets (each with the aforementioned plane) spaced apart along axis 544. The two sets of assemblies are shown in FIGS. 141 and 143 for additional clarity. As can be seen in FIG. 143, the two sets of 3 equally spaced assemblies comprise a first set that includes wheels 542a, 542b, and 542c (hidden) and a second set that includes wheels 542d, 542e, and 542f. Advantageously, a controllable wheel capable of moving in the direction of axis 544 or perpendicular to it is formed. For example, if the array of wheels 542 are on the ground, driving motor 558 causes frame 540 to rotate, which rotates all 6 wheels 542 perpendicular to their axes, forming one large rotating wheel. Driving motor 556 causes worm gear 554 to rotate, thereby causing the 6 wheels 542 to rotate along their axes 546, causing movement along axis 544. Since there are separate driving motors 556 and 558, and since each causes movement of wheel 572 in a different direction than the other, wheel 572 can roll in a 2-dimensional (2D) plane under their power. If one motor is not used in each wheel assembly 572, for example driving motor 556 is not used and allowed to free-wheel, then wheel assembly 572 can be driven in 1 dimension (1D) by driving motor 558 while being pushed or pulled in the other direction, allowing 2D motion but only being able to control one dimension of it.

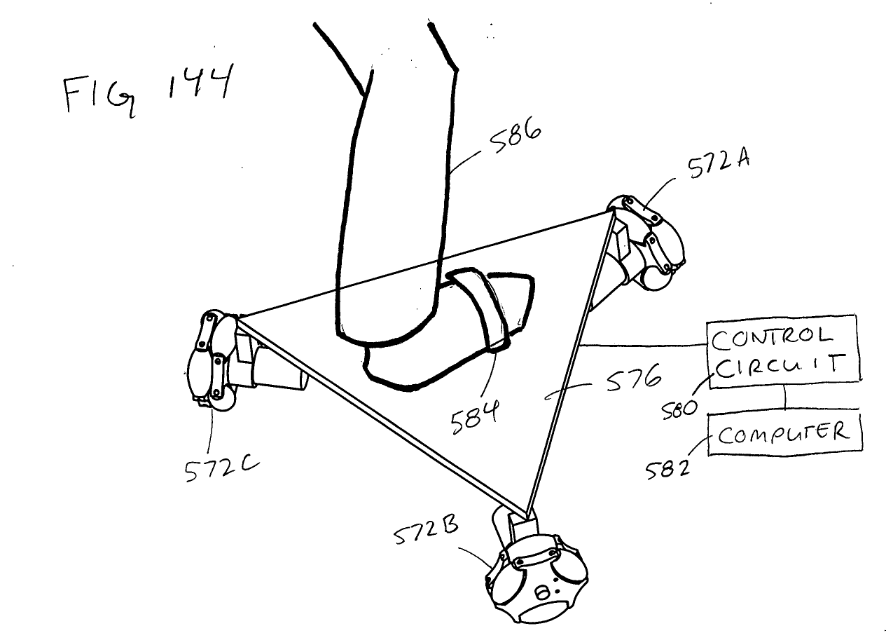

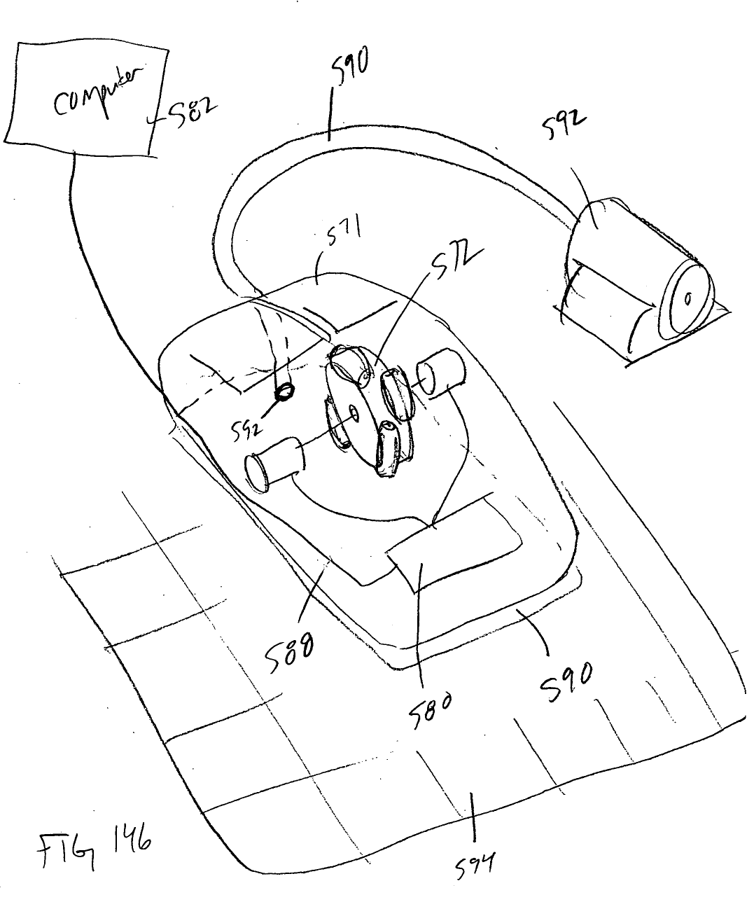

The preferred embodiment of the invention is shown in FIG. 144. As shown in FIG. 144, three of wheel 572 is attached to platform 576, which is held to a body part of user 586, preferably user 586's foot using strap 584. Each of wheel 572 is controlled by control circuit 580, which is commanded by computer 582. Since each wheel 572 can be driven in 2D by the driving motors, frame 576 can roll controllably in two directions. By having three of wheel 572, driving motor 558 of each wheel 572 allows control of platform 576 and user 586 in 2D without the need of driving motor 556 of each wheel 572. If only one wheel 572 is used, as shown for example in FIG. 141, both driving motors 556 and 558 are used so that wheel 572 can be controlled in 2D, allowing platform 576 and user 586 to move in 2D.

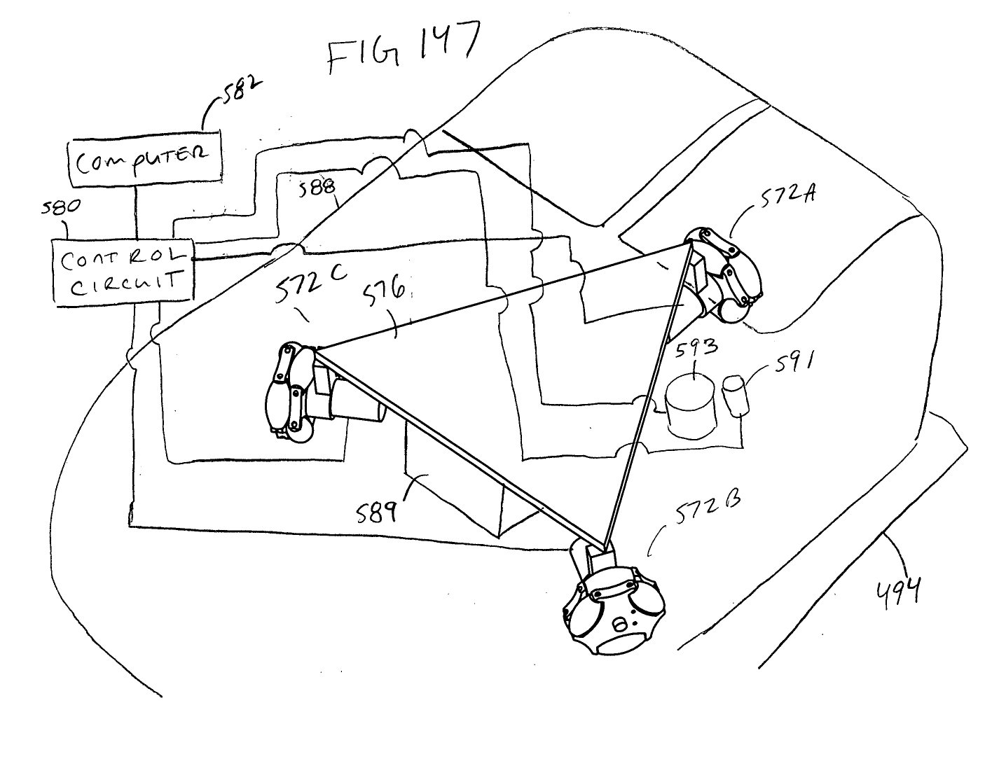

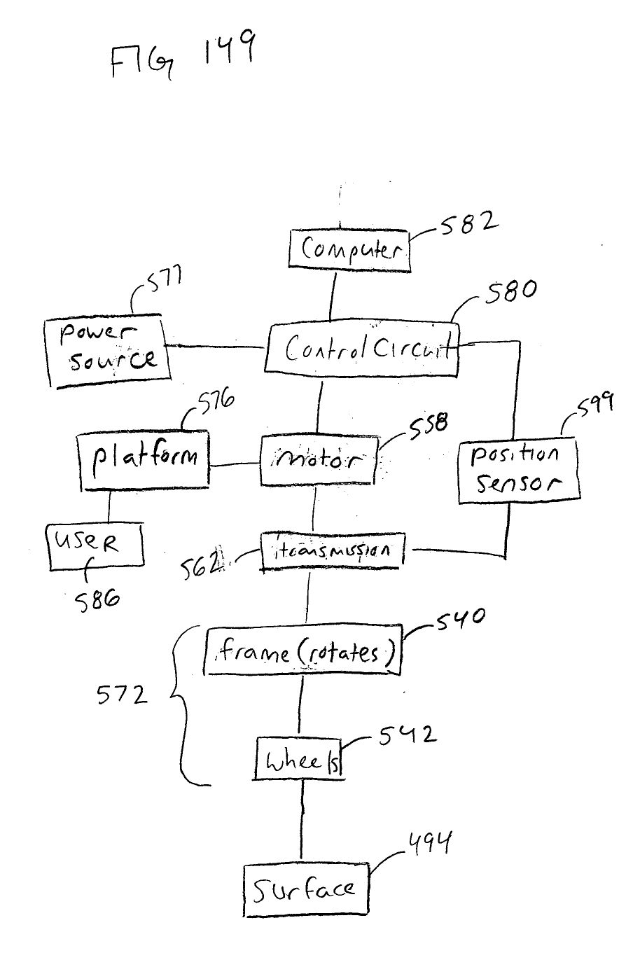

Another embodiment of the invention is shown in FIG. 146. Computer mouse 588 has wheel 572 inside it. Mouse 588, like all computer mice, contains a position sensor to sense the position of mouse 588 on surface 494. Mouse 588 also has button 571. The most commonly used method of sensing the position of mouse 588 on surface 494 is by using a ball that is in contact with two rollers that are positioned approximately perpendicularly to each other, as is well known in the prior art. Computer 582 can control mouse 588 through control circuit 580 (just as was seen in FIG. 144). Mouse 588 has a sealing skirt 590 allowing vacuum pump 592 to create a vacuum underneath mouse 588, so as to pull mouse 588 down to surface 494. Alternatively, surface 594 is ferrous and mouse 588 is magnetic (for example, a magnet is attached to the bottom of mouse 588's housing), so that it is attracted to surface 494. Advantageously, computer 582 can control mouse 588 and create a force reflection interface out of it, in the same way that platform 576 was controllable via wheels 572 (a force reflection device are described in U.S. Pat. No. 6,339,420, which is incorporated herein by reference). For example, it is apparent that mouse 588 is a specialized form of platform 576, as user 586's body part, in this case his or her hand, is being controllably moved by computer 582 and control circuit 580 via wheel 572 in the same manner that another body part, his or her foot, was controllably moved while attached to platform 576. When such a platform is accelerated by driving wheel assembly 572 in either embodiment, a force is imparted to user 586. FIG. 147 shows magnet 589 pulling mouse 588 down to surface 494, and it shows how the use of three of wheel 572 can be used on this embodiment as was done in FIG. 144 in place of the single wheel configuration shown in FIG. 146 (and in FIG. 141). It also showns an alternative position sensing mechanism known in the prior art consisting of camera 593 and LED 591, and it showns platform 576 as a part of mouse 588 (for example, platform 576 is a subassembly that snaps into the housing of mouse 588). The position of platform 576 (and thus also mouse 588) can also be determined by placing optical encoder wheel 595 and optical encoder detector unit 597 on wheel assembly 572 and tracking its rotation about axis 544, as shown in FIG. 143. Such units are well known in the prior art and available from many sources, including U.S. Digital of Vancouver, Wash.

FIG. 149 shows another embodiment of the invention. Six wheels 542 freely rotate about 6 non-coinciding axes around the periphery of a frame 540 as shown in FIG. 143. Frame 540 rotates an axis that is substantially perpendicular to the 6 axes upon which wheels 542 are mounted and is driven by transmission 562, which is driven by motor 558. Frame 540 and the six wheels 542 mounted on it comprise wheel assembly 572. Motor 558 is mounted to platform 576 and driven by control circuit 580. Platform 576 is touches user 586. Control circuit 580 is supplied power for motor 558 by power source 577, which is preferably a rechargeable battery. A position sensor 599 allows control circuit 580 to sense the position of wheel assembly 572 on surface 494. Computer 582 repeatedly (approximately 1000 times per second is preferred) reads the position data from position sensor 599, runs a computing process, and sends a signal to control circuit 580, which in turn uses the signal to set the voltage or current (one determines the other through Ohm's law of V=IR) of motor 558.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

For example, although 6 of wheel 542 have been used in each embodiment, it is possible to use a greater or lesser number of wheels. Likewise, it is possible to use more than 3 of wheel assembly 572 (although using 4 adds complexity, it typically results in greater stability of platform 576 if they are equally spaced about the periphery). Motors 556 and 558 could be replaced by passive components such as friction dampers, magnetorheological fluid dampers, eddy current brakes; particle brakes, etc.

1. A controlled platform assembly, comprising:
a platform;
a frame having an axis of rotation;
a plurality of wheels rotably attached to the frame, each having an axis of rotation; and
a controllable actuation device.
